(19) United States
(12) Patent Application Publication
(10) Pub. No.: US 2019/0081545 A1
(43) Pub. Date: Mar. 14, 2019

(54) Magnetic Propulsion System

(71) Applicant: Harold Ellis Ensle, Arvada, CO (US)

(72) Inventor: Harold Ellis Ensle, Arvada, CO (US)

(21) Appl. No.: 15/701,748

(22) Filed: Sep. 12, 2017

(51) Int. Cl. H02K 41/02

(52) U.S. Cl. CPC H02K 41/02; H02K 2207/00

(57) ABSTRACT

A system for propelling craft which is applicable in any environment. It employs an alternating electric field supplied by capacitors to create an alternating magnetic field. A coil is situated so that the magnetic field(s) interact with various current elements created by the coil. The capacitors are charged and discharged in synchronization with the alternating current in the coil. The changing electric fields in the capacitors create magnetic fields that apply a force to the current elements in the coil which is then transferred to the body of the device. Any reactive force from the magnetic field of the coil is negated since the gaps in the capacitors have no current elements with which the magnetic field of the coil can interact. Therefore the device is propelled in a single direction.

### BACKGROUND

Currently the primary propulsion of craft that is generally applicable to all environments such as in air or space is rocket propulsion. While used with moderate success, this method has been commonly known to have serious limitations. The need to eject mass at high velocities requires enormous energy and the mass needs to be supplied by the craft, particularly if no substance is available from the environment (for example, in the vacuum of space). As distance and velocity requirements increase, the percentage of the weight of the craft that must be allocated to fuel storage becomes unacceptably large. Even when the craft is not accelerating, for example, if hovering at some constant distance from the ground, a large amount of energy still has to be expended to maintain position.

### SUMMARY

The invention of the present application is a system for propelling craft which is applicable in any environment. This has advantage over typical propulsion methods as no mass needs to be ejected. The system employs a number of stacked capacitors each with an even number of plates. The capacitors are charged and discharged to create changing electric fields within the capacitors. This in turn creates magnetic fields around the capacitors. A coil, typically with a ferromagnetic core, is place near the capacitors and physically attached to them, so that segments of the current (and surface current if a ferromagnetic core is included) interact with the magnetic fields generated by the capacitors. The capacitors are charged and discharged by alternating current in synchronization with the current in the coil. If the current is correctly synchronized and the capacitors and coil are correctly aligned, the magnetic field from the capacitors will create a force on the current elements in the coil and ferromagnetic core in a single direction. This force is transferred to the body of the device and propels it as long as the alternating current is maintained The magnetic field created by the coil is missing some current elements (the gaps between the plates) in the capacitors with which to interact, so the capacitors are also propelled in the same direction by their physical attachment to the coil.

### DRAWINGS

FIG. 1 is the illustrative embodiment of a typical magnetic propulsion system.

FIG. 2 is the diagram of a possible circuit that could be used to power the magnetic propulsion system.

### DESCRIPTION OF THE ILLUSTRATIVE EMBODIMENT

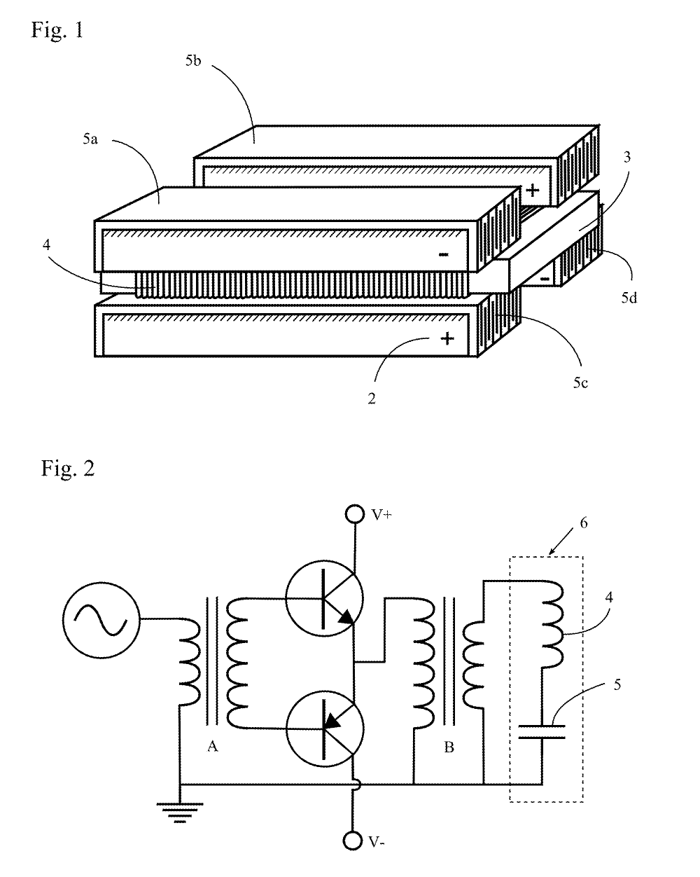

This embodiment (FIG. 1) is composed of one or more capacitors 5 and a coil 4 which would typically be wrapped around a ferromagnetic material 3. While a single stacked capacitor (with any even number of plates) in proper positioning with the coil would be adequate to create the force, the illustrated embodiment described here uses multiple capacitors in a particular arrangement which makes the operation more efficient.

In FIG. 1 there are four stacked capacitors 5a, 5b, 5c, and 5d where the plates of the capacitors are aligned parallel to the current elements on the side of the coil situated between the capacitors. The capacitors are connected in parallel. Notice that a plus or minus sign (for example as indicated by 2) is present on each capacitor. This indicates how the capacitors should be connected so that their magnetic fields work cooperatively on the current elements in the coil to propel it in a single direction. In this embodiment the coil is connected in series with the capacitors. This enforces the synchronization of the magnetic fields generated by the capacitors with the current in the coil. An alternating current drives the device. While any frequency of alternating current would drive the device, it is most efficient to drive the coils and capacitors at their resonant frequency.

FIG. 2 represents a possible driving circuit for the electromagnetic propulsion system. The dotted square 6 encloses the electrical schematic of the components contained in the inductive propulsion system as illustrated in FIG. 1. The coil 4 and ferromagnetic core 3 (displayed as the inductor 4 in FIG. 2) are connected in series to the capacitor 5 which represents the capacitance of all capacitors 5a, 5b, 5c and 5d of FIG. 1 which are connected in parallel. This is accomplished by attaching the leads from the coils to the appropriate conductive surface on the plates (these connections not illustrated in FIG. 1). Notice that the circuit starts with an alternating voltage source where a transformer A is used to link and also increase the voltage for the AB class amplifier at which point the current is amplified. The transformer B can be used to further amplify the current (provided the resistance in the coil and capacitors of the device is low)

The inductor and capacitor arrangement in the electromagnetic propulsion system creates an LC or tank circuit and the initial alternating voltage is tuned to the resonant frequency of the LC circuit. Any wave shape of alternating current would suffice for the propulsion system to succeed. However, this particular driving circuit produces a sinusoidal varying current. This is substantially the simplest circuit that provides the means for synchronizing the alternating current and driving it at resonance. This is used as illustration and there is a wide variety of possible circuits that could be designed to drive the propulsion system.

Looking at FIG. 1, the changing electric fields in the capacitors 5a, 5b, 5c, and 5d create magnetic fields that apply a force to the current elements, both free (the coil 4) and bound (ferromagnetic core 3) created by the coil 4 which is then transferred to the body of the device. When the charge on the capacitors reverse, the current of coil 4 reverses at the same time, thus the net force is always in the same direction.

While an illustrative embodiment has been displayed and described, various modifications and substitutions may be made thereto without departing from the spirit and scope of the present invention. Accordingly, it is to be understood that the present invention has been described by way of illustration and not limitation

What is claimed as new is:

1. A propulsion system comprising:
c. a coil of any cross-sectional shape and with any number of winds,
d. a means to drive an alternating current through said coil, and
a. one or more stacked (multi-layer) capacitors of any number of plates where the magnetic fields that would be created by the charging of said capacitors would only interact substantially with portions of the current elements in said coil and they are aligned such that the force created by said magnetic fields on the current elements in said coil is in a single direction,
b. a means to charge and discharge said capacitors,
e. a means to synchronize the charging of said capacitors with the alternating current in said coil so that they are at the same frequency and that, when said capacitors are fully charged the current through said coil is substantially zero,
whereby the force on the current elements of said coil generated by the magnetic field arising from the change in the electric fields of said capacitors results in a net force which is always in the same direction and said system is propelled in a single direction.

2. The propulsion system of claim 1 wherein said capacitor and said coil are electrically connected in series to provide means to synchronize the variation of charge in said capacitors and alternating current of said coil.

3. The propulsion system of claim 2 wherein means are provided to drive said alternating current at the resonant frequency based on the capacitance of said capacitors and inductance of said coil.

4. The propulsion system of claim 1 wherein said coil has a cross-section of a rectangular shape.

5. The propulsion system of claim 1 wherein said coil is wrapped around a ferromagnetic material.
